(19) United States
(12) Patent Application Publication
(10) Pub. No.: US 2017/0005743 A1
(43) Pub. Date: Jan. 5, 2017

(54) INTERFERENCE MITIGATION

(71) Applicant: TELEFONAKTIEBOLAGET LM ERICSSON (PUBL), Stockholm (SE)

(72) Inventors: Bengt Lindoff, Bjarred (SE); Bo Hagerman, Tyreso (SE); Fredrik Nordstrom, Lund (SE)

(21) Appl. No.: 15/113,186

(22) PCT Filed: Jan. 21, 2014
(86) PCT No.: PCT/EP2014/051085

§ 371 Date: Jul. 21, 2016

(51) Int. Cl. H04J 11/00; H04W 16/14; H04L 5/00; H04W 72/08

(52) U.S. Cl. CPC H04J 11/005; H04W 72/082; H04W 16/14; H04L 5/0073

(57) ABSTRACT

A method is disclosed of a wireless communication device adapted for signal reception over a first frequency region and adapted to operate in connection with a cellular communication network comprising at least a first network node and a second network node. The first network node is adapted to transmit a first, desired, signal over the first frequency region using a first radio access technology and the second network node is adapted to transmit a second, interfering, signal over a second frequency region using a second radio access technology. The first frequency region is partitioned into two or more sub-regions and the second frequency region is one of the sub-regions of the first frequency region. The method comprises performing signal reception over the first frequency region, determining that the signal reception includes reception of the second signal, selecting an interference mitigation method for the second signal based on the determination, performing the selected interference mitigation method for the second signal over the second frequency region, and performing detection of the first signal over the first frequency region. Corresponding computer program product, arrangements and wireless communication device are also disclosed.

### TECHNICAL FIELD

The present invention relates generally to the field of interference mitigation in wireless communication networks.

### BACKGROUND

In a typical deployment of a cellular wireless communication network there may be a large variation of required spatial distribution of service coverage and capacity.

Mobility is a basic feature of cellular networks and basic coverage of service is required (almost) everywhere, which is typically achieved by application of a layer of macro cells supported by wide area coverage base station sites.

Suburban and urban areas may require high data throughput and/or accommodation of a large number of users (particularly so in densely populated areas, busy office areas, malls, sports arenas and the like) while rural areas may not. One deployment solution to handle this diversity situation is to introduce one or more layers (not necessarily contiguous) of low power, small coverage cells underlying the macro cell layer. The underlying cells are typically termed micro, pico, or femto cells and create, together with the macro cells, a heterogeneous network (hetnet).

FIG. 1 schematically illustrates a hetnet deployment with two wide area coverage base station sites 131, 132 serving respective macro cells 141, 142, and two small area coverage nodes 111, 112 serving respective pico cells 121, 122. The coverage areas of base stations and pico nodes typically correspond to an output power used by the respective transmitter. FIG. 1 also illustrates two wireless communication devices (hereinafter also referred to as devices) 101 and 102. The wireless communication device 101 is in the coverage area 141 of the base station 131 and also in the coverage area 121 of the pico node 111. Similarly, the wireless communication device 102 is in the coverage area 141 of the base station 131, in the coverage area 142 of the base station 132 and also in the coverage area 122 of the pico node 112.

If the device 101 is receiving a desired signal from the pico node 111, a signal transmitted from the base station 131 and occupying at least part of the frequency region used to transmit the desired signal may be interfering with the reception of the desired signal. Likewise, if the device 101 is receiving a desired signal from the base station 131, a signal transmitted from the pico node 111 and occupying at least part of the frequency region used to transmit the desired signal may be interfering with the reception of the desired signal.

If the device 102 is receiving a desired signal from the pico node 112, a signal transmitted from the base station 131 (and even more so a signal transmitted from the base station 132) and occupying at least part of the frequency region used to transmit the desired signal may be interfering with the reception of the desired signal. Likewise, if the device 102 is receiving a desired signal from the base station 132, a signal transmitted from the pico node 112 and occupying at least part of the frequency region used to transmit the desired signal may be interfering with the reception of the desired signal.

In a typical hetnet deployment the underlying cells may utilize all—or at least a large part of—the available spectrum resources of the cellular communication system to achieve the requirements (e.g. high peak data rate, high user capacity, etc.), while the macro cells may need to use only a smaller part of the available spectrum resources (e.g. based on frequency reuse) to accommodate its commitments (e.g. coverage, mobility) since the underlying layers offload the macro cells.

FIG. 2 schematically illustrates a few example frequency scenarios that may arise in a hetnet deployment.

Part (a) of FIG. 2 illustrates a first situation, where a device (e.g. device 101 of FIG. 1) is receiving a desired signal 214 transmitted from a network node (e.g. pico node 111 of FIG. 1) using carrier frequency f₀ and a large signal bandwidth (e.g. 10 MHz) resulting in the frequency region 210. The device also experiences an interfering signal 215 transmitted from another network node (e.g. macro node 131 of FIG. 1) using carrier frequency f₁ and a smaller signal bandwidth (e.g. 5 MHz) resulting in the frequency region 212 which is a sub-region of the frequency region 210. No interfering signal is present in the frequency region 211 which is also a sub-region of the frequency region 210.

Part (b) of FIG. 2 illustrates a second situation, where a device (e.g. device 102 of FIG. 1) is receiving a desired signal 224 transmitted from a network node (e.g. pico node 112 of FIG. 1) using carrier frequency f₀ and a large signal bandwidth (e.g. 10 MHz) resulting in the frequency region 220. The device also experiences an interfering signal 225 transmitted from another network node (e.g. macro node 131 of FIG. 1) using carrier frequency f₁ and a smaller signal bandwidth (e.g. 5 MHz) resulting in the frequency region 222 which is a sub-region of the frequency region 220, and an interfering signal 226 transmitted from yet another network node (e.g. macro node 132 of FIG. 1) using carrier frequency f₂ and the smaller signal bandwidth (e.g. 5 MHz) resulting in the frequency region 221 which is also a sub-region of the frequency region 220.

Part (c) of FIG. 2 illustrates a third situation, where a device is receiving a desired signal 234 transmitted from a network node using carrier frequency f₀ and a large signal bandwidth (e.g. 15 MHz) resulting in the frequency region 230. The device also experiences an interfering signal 235 transmitted from another network node using carrier frequency f₁ and a smaller signal bandwidth (e.g. 5 MHz) resulting in the frequency region 233 which is a sub-region of the frequency region 230, and an interfering signal 236 transmitted from yet another network node using carrier frequency f₂ and the smaller signal bandwidth (e.g. 5 MHz) resulting in the frequency region 231 which is also a sub-region of the frequency region 230. No interfering signal is present in the frequency region 232 which is also a sub-region of the frequency region 230.

Thus, due to the use of these multiple layers using more or less overlapping parts of the spectrum and depending on the position of the device, the interference scenario of a device may be very different in different frequency regions of reception. For example, some devices only experience other cell interference in one frequency region of the receiving spectrum (compare with part (a) of FIG. 2), some devices experience other cell interference in all frequency regions of the receiving spectrum, possibly with different power and/or different other characteristics for the respective frequency regions, (compare with part (b) of FIG. 2), some devices experience other cell interference in several—but not all—frequency regions of the receiving spectrum, possibly with different power and/or different other characteristics for the respective frequency regions, (compare with part (c) of FIG. 2) and some devices may not experience any significant interference at all. This type of diversified interference within the same (non-carrier aggregation) reception spectrum is different from typical prior art situations where all pairs of cells heard by a device have completely aligned or completely disjunct signal spectrums and needs to be addressed accordingly.

Situations similar to those illustrated in FIG. 2 may also arise if one or more of the macro cells has an available bandwidth similar to that of the pico nodes, but only schedules part of it.

Similar situations may also arise if one or more of the macro cells have a larger frequency range than the pico cells and the desired signal is transmitted in a macro cell.

The radio access technology used by the different network nodes (e.g. base stations, pico nodes) to transmit desired and interfering signals may be the same radio access technology for all involved network nodes or may differ between the involved network nodes.

For example, network nodes of different layers of a heterogeneous network deployment may use different radio access technology (e.g. UMTS LTE—Universal Mobile Telecommunication Standard, Long Term Evolution—for the pico layer and UMTS HSPA—Universal Mobile Telecommunication Standard, High Speed Packet Access—for the macro layer or WLAN—Wireless Local Area Network, e.g. according to IEEE 802.11—for the pico layer and UMTS LTE for the macro layer).

Further, the different network nodes that create interference in different regions of the receiving spectrum may use the same or different radio access technologies (even if they are not from different layers of a heterogeneous network deployment). For example, one interfering macro node may use UMTS HSPA and another interfering macro node may use UMTS LTE while the pico node may use UMTS LTE, UMTS HSPA or WLAN.

All such examples may experience the above-described situation with diversified (varying, differing) interference within the receiving spectrum.

There is a need for interference mitigation approaches that perform well in situations with diversified interference within the receiving spectrum.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

The inventors have realized that application of traditional interference mitigation approaches in situations with different interference scenario in different frequency regions of reception may be inferior. For example, traditional interference mitigation techniques may not be able to detect an interferer for cancellation when the interferer has a different carrier frequency than the received signal and application in the receiving spectrum of an interference mitigation technique suitable to cancel/suppress interference present only in one frequency region may not be optimal.

It is an object of some embodiments to obviate at least some of the above disadvantages and to provide interference mitigation approaches that take into account the possibility of diversified interference within the receiving spectrum.

According to a first aspect, this is achieved by a method of a wireless communication device adapted for signal reception over a first frequency region and adapted to operate in connection with a cellular communication network comprising at least a first network node and a second network node. The first network node is adapted to transmit a first, desired, signal over the first frequency region using a first radio access technology and the second network node is adapted to transmit a second, interfering, signal over a second frequency region using a second radio access technology.

The first frequency region is partitioned into two or more sub-regions and the second frequency region is one of the sub-regions of the first frequency region.

The method comprises performing signal reception over the first frequency region, determining that the signal reception includes reception of the second signal, selecting an interference mitigation method for the second signal based on the determination, performing the selected interference mitigation method for the second signal over the second frequency region, and performing detection of the first signal over the first frequency region.

The first frequency region is typically a continuous frequency region.

The interference mitigation method may, for example, be an interference cancellation method or an interference suppression method according to any suitable known or future approach.

In some embodiments, no interference mitigation is applied in the sub-regions of the first frequency region that do not form the second frequency region.

In some embodiments, an interference mitigation method (which may be the same or a different interference mitigation method than that applied in the second frequency region) is applied also in at least some of the sub-regions of the first frequency region that do not form the second frequency region.

According to some embodiments, the cellular communication network may be a heterogeneous network and the first and second network nodes may be comprised in different layers of the heterogeneous network.

In some embodiments, the cellular communication network may comprise a third network node adapted to transmit a third signal over a third frequency region using a third radio access technology. The third frequency region (which may be the same of different than the second frequency region) may be one of the sub-regions of the first frequency region. In such embodiments, the method may further comprise (before performing detection of the first signal over the first frequency region) determining that the signal reception includes reception of the third signal, selecting an interference mitigation method for the third signal, and performing the selected interference mitigation method for the third signal over the third frequency region. The third signal may be an interfering signal.

Determining that the signal reception includes reception of the second signal may, according to some embodiments, comprise one or more of:
receiving (from the cellular communication network) a network indication that the second signal is an interfering signal,
detecting (e.g. via a scanning and/or cell search procedure) the second signal in a received signal of the signal reception, and
mapping a geographical position indication of the wireless communication device to an entry of an interference database indicating that the second signal is an interfering signal, wherein the interference database may reside in the wireless communication device, in the cellular communication network, in a cloud-based service (e.g. the Internet), or in any other suitable location.

Determining that the signal reception includes reception of the second signal may, in some embodiments, comprise determining one or more characteristics of the second signal. Selecting the interference mitigation method for the second signal may then be based on the one or more characteristics of the second signal.

The characteristics may comprise one or more of a carrier frequency of the second signal, a transmission bandwidth of the second signal, a received signal strength of the second signal, a ratio between a received signal strength of the first signal and the received signal strength of the second signal, a cell identification of the second network node, a scrambling code used by the second network node, and a timing relation between the first and second network nodes.

Similarly, determining that the signal reception includes reception of the third signal may, in some embodiments, comprise determining one or more characteristics of the third signal and selecting the interference mitigation method for the third signal may then be based on the one or more characteristics of the third signal.

In some embodiments, the first, second and third radio access technologies are the same radio access technology. According to some of these embodiments, the first radio access technology is a variable bandwidth radio access technology and the second and third frequency regions are sub-regions of the first frequency region according to the variable bandwidth radio access technology. For example, the partition of the first frequency region into two or more sub-regions may be in accordance with the variable bandwidth system of UMTS LTE (Universal Mobile Telecommunication Standard—Long Term Evolution) of the Third Generation Partnership Project (3GPP).

In some embodiments, the first radio access technology is a single radio frequency carrier radio access technology.

A signal transmitted by a single radio frequency carrier radio access technology may, for example, be defined as a signal which can (at least theoretically) be down-converted to a baseband signal suitable for demodulation by mixing with a single radio frequency carrier signal. Thus, the first radio access technology is a non-carrier aggregation radio access technology.

A signal transmitted by a single radio frequency carrier radio access technology may carry any suitable signal, for example, an orthogonal frequency division multiplex (OFDM) signal comprising a number of OFDM sub-carriers or a wideband code division multiplex (WCDMA) signal.

A second aspect is a computer program product comprising a computer readable medium, having thereon a computer program comprising program instructions, the computer program being loadable into a data-processing unit and adapted to cause execution of the method according to the first aspect when the computer program is run by the data-processing unit.

A third aspect is an arrangement for a wireless communication device adapted for signal reception over a first frequency region and adapted to operate in connection with a cellular communication network comprising at least a first network node and a second network node. The first network node is adapted to transmit a first, desired, signal over the first frequency region using a first radio access technology and the second network node is adapted to transmit a second, interfering, signal over a second frequency region using a second radio access technology.

The first frequency region is partitioned into two or more sub-regions and the second frequency region is one of the sub-regions of the first frequency region.

The arrangement comprises a determiner adapted to determine that a received signal comprises the second signal, a selector adapted to select an interference mitigation method for the second signal responsive to the determiner determining that the received signal comprises the second signal and based on the determination, and an interference mitigator adapted to perform the selected interference mitigation method for the second signal over the second frequency region to provide an interference mitigated signal.

According to some embodiments, the arrangement may further comprise a signal detector adapted to perform, on the interference mitigated signal, detection of the first signal over the first frequency region.

In some embodiments, the arrangement may further comprise a signal receiver adapted to perform signal reception over the first frequency region and provide the received signal as an input to the interference mitigator.

The determiner may, according to some embodiments, be adapted to determine that the received signal comprises the second signal by detecting the second signal in the received signal of the signal receiver.

The signal receiver may, in some embodiments, be further adapted to receive, from the cellular communication network, a network indication that the second signal is an interfering signal and the determiner may be adapted to determine that the received signal comprises the second signal based on the network indication.

In some embodiments, the arrangement may further comprise a positioning unit adapted to determine a geographical position indication of the wireless communication device. In such embodiments, the determiner may be adapted to determine that the received signal comprises the second signal by mapping the geographical position indication of the wireless communication device to an entry of an interference database indicating that the second signal is an interfering signal.

A fourth aspect is an arrangement for a wireless communication device adapted for signal reception over a first frequency region and adapted to operate in connection with a cellular communication network comprising at least a first network node and a second network node. The first network node is adapted to transmit a first, desired, signal over the first frequency region using a first radio access technology and the second network node is adapted to transmit a second, interfering, signal over a second frequency region using a second radio access technology.

The first frequency region is partitioned into two or more sub-regions and the second frequency region is one of the sub-regions of the first frequency region.

The arrangement comprises a control unit adapted to cause the wireless communication device to perform signal reception over the first frequency region, determine that the signal reception includes reception of the second signal, select an interference mitigation method for the second signal based on the determination, perform the selected interference mitigation method for the second signal over the second frequency region, and perform detection of the first signal over the first frequency region.

A fifth aspect is a wireless communication device comprising the arrangement according to any of the third and fourth aspect.

In some embodiments, the third and fourth aspects may additionally have features identical with or corresponding to any of the various features as explained above for the first aspect.

An advantage of some embodiments is that they provide interference mitigation approaches that take into account the possibility of diversified interference within the receiving spectrum.

Another advantage of some embodiments is that they provide improved throughput and/or system capacity.

Yet another advantage of some embodiments is that they improve desired signal reception performance of a wireless communication device.

### BRIEF DESCRIPTION OF THE DRAWINGS

Further objects, features and advantages will appear from the following detailed description of embodiments, with reference being made to the accompanying drawings, in which:

FIG. 1 is a schematic drawing illustrating an example heterogeneous network scenario according to some embodiments;

FIG. 2 is a schematic drawing illustrating various example interference situations of a heterogeneous network according to some embodiments;

FIG. 3 is a flowchart illustrating example method steps according to some embodiments;

FIG. 4 is a block diagram illustrating an example arrangement according to some embodiments; and

FIG. 5 is a schematic drawing illustrating an example computer program product according to some embodiments.

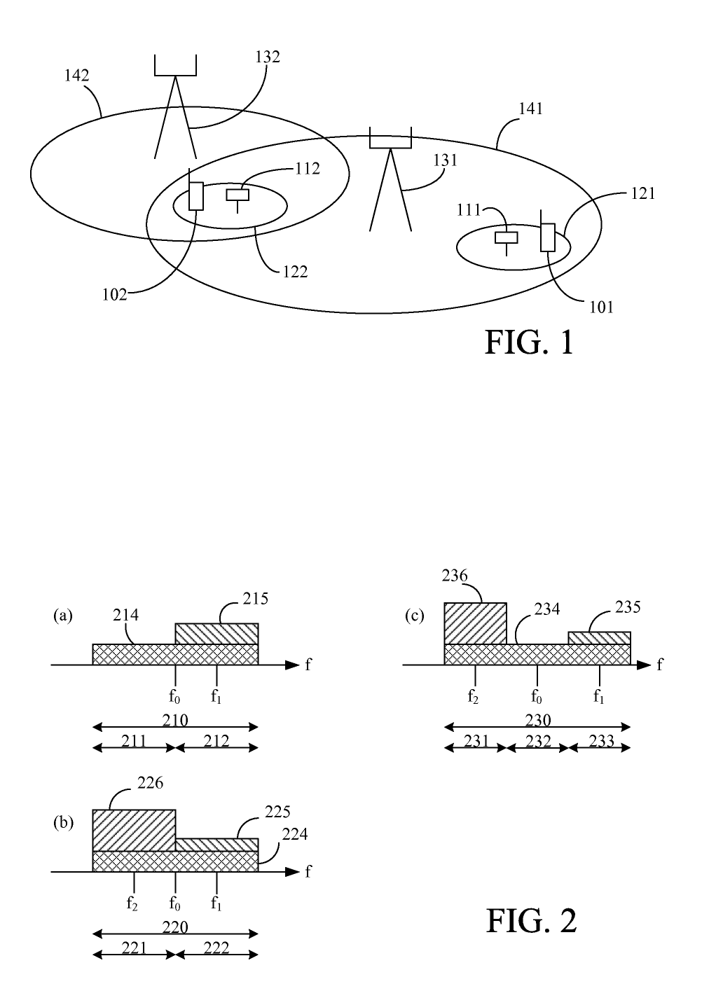

### DETAILED DESCRIPTION

As a non-limiting example, it will be assumed in this description that the first, second and third radio access technologies are the same radio access technology, and that the radio access technology is a variable bandwidth radio access technology using a single radio frequency carrier. This will be referred to in the following as variable bandwidth single carrier radio access technology, and it is understood that this includes OFDM transmission.

In the following, embodiments will be described where different interference situations in different frequency sub-regions of a receiving spectrum are detected and separate interference mitigation methods are selected and applied for the different frequency sub-regions based on the detection.

Thus, an interference mitigation approach suitable for situations with intra-frequency sub-band interfering cells is provided. Typically, the interfering cell(s) causing such a situation have different carrier frequency and/or different signal bandwidth compared to a desired signal and at least part of each interfering signal spectrum overlaps with part of the desired signal spectrum. Such situations may arise, for example, in connection with heterogeneous network deployments.

Embodiments presented herein solve one or more of a number of problems associated with interference mitigation (IM) of a receiver of a wireless communication device if such a receiver would operate in accordance with typical prior art cellular deployment approaches (for example, assuming that the same carrier frequency and system bandwidth is used by an intra-frequency interfering signal as by the desired signal). Such a receiver is not able to detect an interfering signal having a different carrier frequency. Furthermore, such a receiver is not able to take into account that interference signals in different frequency sub-regions may have different signal strength (even zero signal strength in one or more sub-regions), and that the signal-to-interference ratio (SIR) and cell load may consequently be different in different sub-regions. Yet further, such a receiver is not able to take into account that different interfering cells may have different timings and/or different frequency offsets.

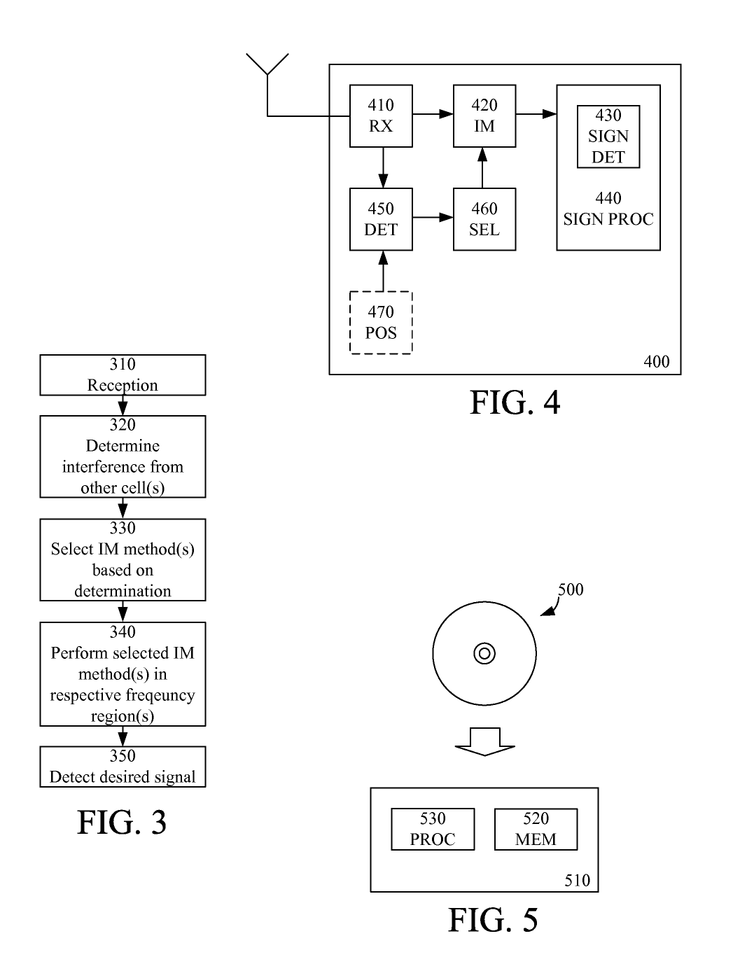

FIG. 3 illustrate an example method according to some embodiments for interference mitigation in situations with different interference situations in different frequency sub-regions of a receiving spectrum.

The method may, for example, be performed by a wireless communication device operating in a cellular communication network using a variable bandwidth single carrier radio access technology. When the device is receiving a first, desired, signal from a first network node over a first frequency region (compare with regions 210, 220, 230 of FIG. 2) it may experience interference in the form of one or more (second, third, etc.) interfering signals transmitted from respective other (second, third, etc.) network nodes. Each of the interfering signals may occupy a frequency region that is a sub-region of the first frequency region (compare with regions 212, 221, 222, 231, 233 of FIG. 2). For example, the cellular communication network may be a heterogeneous network and the first network node may be comprised in a different layer of the heterogeneous network than the network nodes transmitting the interfering signals.

The method starts in step 310 where signal reception is performed over the first frequency region. Thus, the desired signal is received along with any interfering signal in the first frequency region.

In step 320, it is determined whether or not there are any interfering signals in the first frequency region that should be subjected to interference mitigation. If there are no such interfering signals, the method ends in step 320. If there are one or more such interfering signals, suitable characteristics of those interfering signals may also be determined in step 320.

The determination that there is one or more interfering signals in the first frequency region may comprise detecting such signals based on the signal reception of step 310. The detection may comprise application of any suitable known or future method, for example, scanning and/or cell search.

Alternatively or additionally, the determination that there is one or more interfering signals in the first frequency region may comprise receiving a network indication from the cellular communication network that the device is in a position (e.g. based on a current cell of the device, a geographical location of the device, or similar) where there is (or is a risk of) a situation with one or more interfering signals occupying a sub-region of the receiving frequency region. In some embodiments, the network indication is simply a flag that is set when the device may experience a situation with different interference situations in different frequency sub-regions of a receiving spectrum. In some embodiments, the network indication may also comprise characteristics of the interfering signal(s).

Yet alternatively or additionally, the determination that there is one or more interfering signals in the first frequency region may comprise mapping a geographical position indication (e.g. a Global Positioning System—GPS—indication) of the wireless communication device to an entry of an interference database. The entry of interference database indicating that there is (or is a risk of) a situation with one or more interfering signals occupying a sub-region of the receiving frequency region. In some embodiments, the entry of interference database is simply a flag that is set when the device may experience a situation with different interference situations in different frequency sub-regions of a receiving spectrum. In some embodiments, the entry of interference database may also comprise characteristics of the interfering signal(s).

In a typical embodiment, the device does cell search on regular basis in order to find neighboring cells as potential handover candidates. To implement step 320, the cell search is made also on carrier frequencies corresponding to (partial) overlap with the desired signal spectrum. The device may perform this cell search in response to, or based on, information (e.g. related to a neighboring cell list) received from the network in a network indication. Alternatively or additionally, the device may perform this cell search in accordance with stored history information of cells found and interference situations detected earlier, possibly in combination with position information. Detection of a cell as a result of a cell search procedure typically results in a physical or global cell identification being acquired.

Example suitable characteristics of the interfering signals that may be determined from the received signal or otherwise acquired (e.g. from the IF NB cell list) in step 320 include the carrier frequency of each of the interfering signals, the frequency grid of each of the interfering signals, the transmission bandwidth of each of the interfering signals, the received signal strength of each of the interfering signals, the SIR of each of the sub-regions of the first frequency region, the ratio between the received signal strength of the desired signal and the received signal strength of each of the interfering signals, the cell identification of the network node of each of the interfering signals, the scrambling code used by the network node of each of the interfering signals, the timing difference between a network node transmitting an interfering signal and the serving network node, the frequency offset between a network node transmitting an interfering signal and the serving network node, the timing difference between two network nodes transmitting respective interfering signals, the frequency offset between two network nodes transmitting respective interfering signals, a length of the cyclic prefix of the interfering and/or desired signal, a length of a control symbol of the interfering and/or desired signal, a cell load related to an interfering cell, a transmission mode of a network node transmitting an interfering signal, number of transmit antennas used by a network node transmitting an interfering signal, number of cell-specific reference signals (CRS) port used by a network node transmitting an interfering signal, control region size, data-to-pilot power ratio, radio access technology used (e.g. UMTS LTE, UMTS HSPA, WLAN), etc. The determination of these and other characteristics may be performed by application of any suitable known or future methods.

In step 330, it is selected how the detected interference signals are to be mitigated. This typically comprises selecting a suitable interference mitigation method for each of the detected interference signals. The selection of interference mitigation method for each of the detected interference signals is typically done based on one or more of the characteristics of the interfering signal(s) achieved in step 320.

The interference mitigation method may be selected from an ensemble of possible interference mitigation methods, and the ensemble of possible interference mitigation methods may comprise any suitable known or future interference mitigation methods (e.g. interference cancellation (IC) methods and/or interference suppression methods). The selection may, for example, be based on cell identification(s) and characteristics of detected interfering cells.

The selection of interference mitigation method in step 330 may comprise selection of the type of method and also selection of parameters to use for a particular type of method.

The selection of interference mitigation method may also include selecting which parts of the signals should be mitigated. Examples of signal parts that may be mitigated include control signals, broadcast signals, data signals, pilot signals, semi statistical data signals (e.g. broadcast channel—BCH), synchronization signals, etc.

In a typical application suitable for UMTS LTE, step 330 also comprises determining which resource elements the interference mitigation should be applied to.

Example interference mitigation methods include cancelling known signals (e.g. pilots), decoding, re-encoding and subtracting signals (e.g. data/control signals), maximum likelihood (ML) approaches, reduced ML approaches, recursive ML approaches, minimum mean square estimation (MMSE) approaches, successive interference cancellation (SIC), noise suppression approaches (e.g. interference rejection combining—IRC), etc. Other example interference mitigation methods (e.g. Symbol Level Interference Cancellation (SLIC), Code Word Interference Cancellation (CWIC) and enhanced linear minimum mean square estimation IRC (E-LMMSE-IRC)) may be found in Third Generation Partnership Project (3GPP) Study Item “Network Assisted Interference Cancellation” TR36.866.

One example of how the interference mitigation methods may be selected for different sub-regions includes selecting cancellation of different types of signals in relation to different cells depending on the strength of the interfering signals. Such an example may comprise cancellation of known signals—one or more of: pilot signals, synchronization signals (e.g. primary/secondary synchronization signals, PSS/SSS), reference signals (e.g. cell-specific reference signals, CRS), a physical broadcast channel (PBCH), etc.—and unknown signals—one or more of: control signals (e.g. a physical downlink control channel (PDCCH)), data signals (e.g. a physical downlink shared channel (PDSCH)), etc.—for SIR values above a first threshold.

The example may also include cancellation only of known signals for SIR values between the first threshold and a second threshold, and no cancellation for SIR values below the second threshold.

In some embodiments, interference suppression is applied in stead of interference cancellation for SIR values between the first and second thresholds, and/or for SIR values below the second threshold.

In one alternative, the signal strength of the respective interfering signal and corresponding thresholds are used in stead of SIR values.

In another example (which may be combined with the previous example), different interference mitigation methods are used on the different sub-regions depending on the timing and/or the carrier frequency (hence frequency grid for resource elements in UMTS LTE) of the respective interfering cell relative the cell transmitting the desired signal (and/or relative other interfering cells).

If the interfering cell and the serving cell are time aligned and synchronized, a default interference mitigation method (e.g. SLIC where interfering signal is estimated, regenerated and subtracted on symbol level) may be used. If the interfering cell and the serving cell are not synchronized, an IRC approach or an advanced IC method (see, for example, WO2013185854A1) taking into account the timing difference—e.g. modeling the introduced inter symbol interference—may be applied.

If the frequency grid of the interfering cell is aligned with the frequency grid of the serving cell default interference mitigation method may be used and if the frequency grids are non-aligned an IRC or an advanced IM method—taking into account the ICI introduced due to non-aligned frequency grid—may be applied.

In some embodiments, it is selected to apply no interference mitigation in one or more sub-regions. Example reasons for not applying interference mitigation to a sub-region may be that no interfering signal is detected in that sub-region, that the signal strength of the interfering signal in that sub-region is low, that there are hardware and/or software complexity constraints associated with the wireless communication device making it cumbersome or impossible to perform interference mitigation for many interfering cells in different sub-regions.

Thus, in some situations it may be determined that one or more of the detected interference signals is not to be mitigated (e.g. if the SIR for the affected sub-region(s) is above a threshold indicating an acceptable SIR value).

In some situations the same interference mitigation method may be selected for two or more different interference signals and/or for two or more different sub-regions (e.g. if similar SIR values are experienced and/or if the timing is similar).

The selection of interference mitigation method(s) in step 330 may, for example, be performed based on triggering events (e.g. when new cells are detected, when a relative timing and/or a signal strength exceeds a threshold) or at regular time intervals.

Then, in step 340, the selected interference mitigation method(s) are performed, that is, a selected interference mitigation method is applied for each frequency sub-region of the first frequency region (assuming that the selection may comprise determining that no interference mitigation should be performed for one or more sub-regions and/or determining that the same interference mitigation method should be applied to two or more of the sub-regions and/or determining that two interference mitigation methods should be should be performed for one or more sub-regions—e.g. when two cells interfere the same sub-region). If more than one interference mitigation methods are selected, they may be applied in any order or in parallel, as suitable. Finally, the desired signal is detected in step 350.

Returning to the examples of FIG. 2, the described embodiments may result in (for part (a)) application in sub-region 212 of an interference mitigation method suitable for signal 215 and no interference mitigation in sub-region 211, (for part (b)) application in sub-region 222 of an interference mitigation method suitable for signal 225 (or no interference mitigation if the signal 225 is weak enough) and application in sub-region 221 of an interference mitigation method suitable for signal 226, (for part (c)) application in sub-region 233 of an interference mitigation method suitable for signal 235 (or no interference mitigation if the signal 235 is weak enough), application in sub-region 231 of an interference mitigation method suitable for signal 236 and no interference mitigation in sub-region 232.

FIG. 4 schematically illustrate an example arrangement 400 according to some embodiments for interference mitigation in situations with different interference situations in different frequency sub-regions of a receiving spectrum. The example arrangement 400 may, for example be comprised in a wireless communication device and/or may be adapted to perform the method according to FIG. 3.

The arrangement 400 comprises a receiver (RX) 410, a determiner (DET) 450, a selector (SEL) 460, an interference mitigator (IM) 420, and a signal processor (SIGN PROC) 440.

The receiver 410 is adapted to perform signal reception over the first frequency region (compare with step 310 of FIG. 3) and provide the received signal as an input to the interference mitigator 420 and to the determiner 450.

The determiner 450 is adapted to determine whether or not there are interfering signal component(s) in sub-regions of a received signal spectrum (compare with step 320 of FIG. 3). It may, for example, comprise one or more of a signal detector, a characteristics determiner, a network indication reader and an interference database (or means to access an interference database).

In some embodiments, the arrangement 400 may also comprise a positioning unit (POS) 470 adapted to determine a geographical position indication of the wireless communication device comprising the arrangement 400 and supply the geographical positioning indication to the determiner 450 for mapping the geographical position indication to an entry of an interference database indicating the interference situation.

The selector 460 is adapted to select one or more interference mitigation methods for use in different sub-regions based on the result of the determiner 450 (compare with step 330 of FIG. 3).

The interference mitigator 420 is adapted to perform the interference mitigation method(s) selected by the selector 460 in the respective sub-regions of the received signal from the receiver 410 (compare with step 340 of FIG. 3).

The interference mitigated signal output from the interference mitigator 420 is supplied to a signal processor (SIGN PROC) 400 for further processing. The further processing comprises detection of the desired signal (compare with step 350 of FIG. 3) by a signal detector (SIGN DET) 430. In some embodiments, one or more of the detector 450, the selector 460 and the interference mitigator 420 may be comprised in the signal processor 440.

The described embodiments and their equivalents may be realized in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a wireless communication device) comprising circuitry/logic or performing methods according to any of the embodiments. The electronic apparatus may, for example, be a portable or handheld mobile radio communication equipment, a mobile radio terminal, a mobile telephone, a communicator, an electronic organizer, a smartphone, a computer, a notebook, a USB-stick, a plug-in card, an embedded drive, a sensor, a modem, a machine type communication (MTC) device, or a mobile gaming device.

For example, a wireless communication device may comprise an arrangement according to FIG. 4 and/or an arrangement comprising a control unit adapted to cause the wireless communication device to perform the method according to FIG. 3.

According to some embodiments, a computer program product comprises a computer readable medium such as, for example, a diskette or a CD-ROM as illustrated by the example CD-ROM 500 of FIG. 5. The computer readable medium may have stored thereon a computer program comprising program instructions. The computer program may be loadable into a data-processing unit 530, which may, for example, be comprised in a mobile terminal 510. When loaded into the data-processing unit, the computer program may be stored in a memory 520 associated with or integral to the data-processing unit 530. According to some embodiments, the computer program may, when loaded into and run by the data-processing unit, cause the data-processing unit to execute method steps according to, for example, the method shown in FIG. 3.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1. A method of a wireless communication device adapted for signal reception over a first frequency region and adapted to operate in connection with a cellular communication network comprising at least a first network node and a second network node, wherein the first network node is adapted to transmit a first signal over the first frequency region using a first radio access technology, the second network node is adapted to transmit a second signal over a second frequency region using a second radio access technology, the first frequency region is partitioned into two or more sub-regions, the second frequency region is one of the sub-regions of the first frequency region, the first signal is a desired signal and the second signal is an interfering signal, the method comprising:
performing signal reception over the first frequency region;
determining that the signal reception includes reception of the second signal;
selecting an interference mitigation method for the second signal based on the determination;
performing the selected interference mitigation method for the second signal over the second frequency region; and
performing detection of the first signal over the first frequency region.

2. The method of claim wherein the cellular communication network is a heterogeneous network and wherein the first and second network nodes are comprised in different layers of the heterogeneous network.

3. The method of claim 1, wherein the cellular communication network comprises a third network node adapted to transmit a third signal over a third frequency region using a third radio access technology, the third frequency region is one of the sub-regions of the first frequency region, and the interference mitigation method for the second signal is a first interference mitigation method, the method further comprising, before performing detection of the first signal over the first frequency region:
determining that the signal reception includes reception of the third signal;
selecting a second interference mitigation method for the third signal; and
performing the selected second interference mitigation method for the third signal over the third frequency region.

4. The method of any claim 1, wherein determining that the signal reception includes reception of the second signal comprises one or more of:
receiving, from the cellular communication network, a network indication that the second signal is an interfering signal;
detecting the second signal in a received signal of the signal reception; and
mapping a geographical position indication of the wireless communication device to an entry of an interference database indicating that the second signal is an interfering signal.

5. The method of claim 1, wherein determining that the signal reception includes reception of the second signal comprises determining one or more characteristics of the second signal and wherein selecting the interference mitigation method for the second signal is based on the one or more characteristics.

6. The method of claim wherein the characteristics comprise one or more of:
a carrier frequency of the second signal;
a transmission bandwidth of the second signal;
a received signal strength of the second signal;
a ratio between a received signal strength of the first signal and the received signal strength of the second signal;
a cell identification of the second network node;
a scrambling code used by the second network node; and
a timing relation between the first and second network nodes.

7. A nontransitory computer readable storage medium, having thereon a computer program comprising program instructions, the computer program being loadable into a data-processing unit and adapted to cause execution of a method when the computer program is run by the data-processing unit, wherein the method is a method of a wireless communication device adapted for signal reception over a first frequency region and adapted to operate in connection with a cellular communication network comprising at least a first network node and a second network node, wherein the first network node is adapted to transmit a first signal over the first frequency region using a first radio access technology, the second network node is adapted to transmit a second signal over a second frequency region using a second radio access technology, the first frequency region is partitioned into two or more sub-regions, the second frequency region is one of the sub-regions of the first frequency region, the first signal is a desired signal and the second signal is an interfering signal, and wherein the method comprises:
performing signal reception over the first frequency region;
determining that the signal reception includes reception of the second signal;
selecting an interference mitigation method for the second signal based on the determination;
performing the selected interference mitigation method for the second signal over the second frequency region; and
performing detection of the first signal over the first frequency region.

8. An arrangement for a wireless communication device adapted for signal reception over a first frequency region and adapted to operate in connection with a cellular communication network comprising at least a first network node and a second network node, wherein the first network node is adapted to transmit a first signal over the first frequency region using a first radio access technology, the second network node is adapted to transmit a second signal over a second frequency region using a second radio access technology, the first frequency region is partitioned into two or more sub-regions, the second frequency region is one of the sub-regions of the first frequency region, the first signal is a desired signal and the second signal is an interfering signal, the arrangement comprising:
a determiner adapted to determine that a received signal comprises the second signal;
a selector adapted to select an interference mitigation method for the second signal responsive to the determiner determining that the received signal comprises the second signal and based on the determination; and
an interference mitigator adapted to perform the selected interference mitigation method for the second signal over the second frequency region to provide an interference mitigated signal.

9. The arrangement of claim 8 wherein the cellular communication network comprises a third network node adapted to transmit a third signal over a third frequency region using a third radio access technology, the third frequency region is one of the sub-regions of the first frequency region, and the interference mitigation method for the second signal is a first interference mitigation method, and wherein:
the determiner is further adapted to determine that the received signal comprises the third signal;
the selector is further adapted to select a second interference mitigation method for the third signal responsive to the determiner determining that the received signal comprises the third signal and based on the determination; and
the interference mitigator is further adapted to perform the selected second interference mitigation method for the third signal over the third frequency region to provide the interference mitigated signal.

10. The arrangement of claim 8, further comprising a signal detector adapted to perform, on the interference mitigated signal, detection of the first signal over the first frequency region.

11. The arrangement of claim 8, further comprising a signal receiver adapted to perform signal reception over the first frequency region and provide the received signal as an input to the interference mitigator.

12. The arrangement of claim 11 wherein the determiner is adapted to determine that the received signal comprises the second signal by detecting the second signal in the received signal of the signal receiver.

13. The arrangement of claim 11, wherein the signal receiver is further adapted to receive, from the cellular communication network, a network indication that the second signal is an interfering signal and wherein the determiner is adapted to determine that the received signal comprises the second signal based on the network indication.

14. The arrangement of claim 8, further comprising a positioning unit adapted to determine a geographical position indication of the wireless communication device and wherein the determiner is adapted to determine that the received signal comprises the second signal by mapping the geographical position indication of the wireless communication device to an entry of an interference database indicating that the second signal is an interfering signal.

15-20. (canceled)

21. A wireless communication device comprising the arrangement according to claim 8.
